(19) United States
(12) Patent Application Publication
(10) Pub. No.: US 2024/0191165 A1
(43) Pub. Date: Jun. 13, 2024

(54) ALCOHOL-FREE BEER ENRICHED WITH PROTEINS AND METHOD FOR THE MANUFACTURE THEREOF

(71) Applicant: Thrive BV, Sint-Denijs-Westrem (BE)

(72) Inventors: Laurens Alexander D'HOORE, Sint-Denijs-Westrem (BE); Florian Alexander Ludger Norbert THESSELING, Sint-Denijs-Westrem (BE); Kevin Joan VERSTREPEN, Leuven (BE); Stijn Louis Ursula SPAEPEN, Oud-Heverlee (BE)

(21) Appl. No.: 18/556,551

(22) PCT Filed: Apr. 23, 2022
(86) PCT No.: PCT/EP2022/060758

§ 371 Date: Oct. 20, 2023

(30) Foreign Application Priority Data
Apr. 23, 2021 (BE) BE2021/5317

(51) Int. Cl. C12H 3/00; C12C 5/02; C12C 7/04; C12C 11/00

(52) U.S. Cl. CPC C12H 3/00; C12C 5/02; C12C 7/04; C12C 11/003

(57) ABSTRACT

The invention relates to a method for making an alcohol-free beer that is free from coagulated matter, with an alcohol content of not more than 0.5% (v/v), comprising the steps of fermentation of a wort, addition of a hydrolyzed protein after fermentation of the wort and pasteurization. The invention further relates to alcohol-free beer that is free from coagulated matter, with an alcohol content of not more than 0.5% (v/v), which contains one or more hydrolyzed proteins. Preferably the beer also contains maltose and maltotriose and the total content of maltose and maltotriose is between 5 and 80 g/l. The beer has a pleasant taste and can be drunk as a typical beer, wherein in addition it contains the necessary ingredients to promote recovery after sports activities.

The present invention relates to the manufacture of an alcohol-free beer that is enriched with proteins and consequently can be used as a sports drink. The present invention further relates to an alcohol-free beer so obtained.

Intensive energy consuming sports activities such as cycle racing, skiing, tennis, fitness training, baseball, football and general athletics are increasing in popularity as leisure activities for adults. Often after such activities the sportsmen or sportswomen meet up with each other in a canteen or cafe to discuss things over a drink. The drinks usually consumed are either so-called ‘soft drinks’ such as cola or lemonade, or alcoholic drinks. None of these drinks meet the nutritional requirements after sports activities. In addition, alcoholic drinks lead to dehydration and put a strain on the body. Therefore they hamper recovery. Alcohol-free beers are less harmful in this respect but still have the disadvantage that just like ‘soft drinks’ they do not satisfy the nutritional requirements after sports activities. These beers are usually brewed in the same way as the alcohol-containing equivalents, the alcohol being removed for example by distillation or reverse osmosis after the brewing process. Although attempts are made to get as close as possible to the taste of the alcohol-containing equivalent, the process of removing the alcohol nevertheless has a considerable effect on the taste of the beer, so that the regular beer drinker is not really convinced by such beers. Alternatively, an alcohol-free beer can be brewed with a special yeast that only converts a small amount of sugar into alcohol. Such a process is described in WO 2014/135673, in which the yeast used is a Pichia kluyveri yeast strain. Since the type of yeast used largely determines the taste of the beer, it will usually be difficult or impossible to come close to the taste of an alcohol-containing equivalent. Although it is described in that publication that the taste of ordinary alcohol-containing pilsner beers such as STELLA® and CARLSBERG® can be obtained, this will be difficult for more specialized beers such as PALM® and LEFFE®. Such yeasts also sometimes produce byproducts that create an unpleasant flavor, such as unpleasant sulfur-containing compounds. Moreover, because of the very small amount of alcohol and often higher sugar content, alcohol-free beers must be pasteurized to ensure a good shelf life of the beer.

To promote recovery of the body and muscles, besides hydration, supply of sugars and in particular proteins and/or amino acids is desirable. For this purpose, special sports drinks have been developed, which are totally oriented at providing optimal recovery. However, the taste of these drinks makes them less suitable and pleasant to drink in a social context after sports activities such as mentioned above. In addition, such drinks are not usually available in canteens and cafes.

US 2003/0134007 describes the addition of proteins, peptides, amino acids and vitamin supplements to a beer that has been brewed in a usual manner and is thus an alcohol-containing beer. In US 2003/0157218, proteins, optionally hydrolyzed proteins, minerals, antioxidants and vitamins are added to an alcohol-containing beer. Although this beer then contains components that meet the nutritional requirements for recovery after sports activities, the presence of alcohol in the beer is still an important disadvantage for optimal recovery.

The inventors found that adding proteins and/or amino acids to an alcohol-free beer led to coagulation in the beer after the necessary pasteurization thereof. In addition, the taste of such beers was suboptimal and often even less attractive than the usual alcohol-free beers. There is therefore a need to develop an alcohol-free beer with nutritional supplements that can promote recovery after sports activities. It is desirable that such a beer has a pleasant and tempting taste, preferably is clear and is free from coagulated matter. It is also desirable to find a solution that is compatible with the method of production of an alcohol-free beer including a pasteurization step in the production process.

In a first aspect, the invention relates to a method for making an alcohol-free beer that is free from coagulated matter, with an alcohol content of not more than 0.5% (v/v), preferably not more than 0.4% (v/v), comprising the steps of fermentation of a wort, addition of a hydrolyzed protein and pasteurization. Preferably the hydrolyzed protein is added after fermentation of the wort.

In a preferred embodiment of the first aspect, the invention relates to a method for making an alcohol-free beer that is free from coagulated matter, comprising the steps of
a. supplying a wort,
b. fermenting the wort with a yeast for example at a temperature from 18° C. to 25° C.,
c. ending the fermentation by cooling the wort to obtain a fermented wort,
d. filtering and/or centrifuging the fermented wort,
e. if the alcohol content in the fermented wort is 0.5% (v/v) or more, reducing the alcohol content in the fermented wort to less than 0.5% (v/v), preferably less than 0.4% (v/v),
f. adding a hydrolyzed protein to the fermented wort, and
g. pasteurizing.

In a second aspect, the invention relates to an alcohol-free beer that is free from coagulated matter, with an alcohol content of not more than 0.5% (v/v), preferably not more than 0.4% (v/v), which contains one or more hydrolyzed proteins. In a preferred embodiment the amount of hydrolyzed protein is between 0.5% (w/v) and 10% (w/v). The beer according to the second aspect is also pasteurized.

It was found that on adding a hydrolyzed protein to the fermented wort, the resultant alcohol-free beer could be pasteurized without coagulation occurring or without substantial coagulation occurring, in other words a beer that is free from coagulated matter is obtained. “Substantial coagulation” means here that not more than 0.1% (w/w), preferably not more than 0.05% (w/w) of sediment has formed. An alcohol-free beer can thus be obtained that is clear or slightly turbid.

In a third aspect, the invention relates to an alcohol-free beer that can be obtained by the method according to the first aspect.

### Definitions

Unless otherwise indicated, the following terms have the following definitions:
“alcohol”: this means ethanol;
“alcohol content”: content of ethanol or ethyl alcohol;
“alcohol-free”: an amount of ethanol that is less than 0.50% (v/v), preferably not more than 0.40% (v/v) and most preferably not more than 0.35% (v/v);
“beer free from coagulated matter”: signifies that the beer is free from coagulated matter or sediment or that the maximum amount of sediment or coagulated matter is not more than 0.1% (w/v), preferably not more than 0.05% (w/v);
“wort”: has the usual meaning as known in a beer brewing process and is a sugar-containing liquid extract that is obtained in the mashing of a malt in the beer brewing process;
“beer”: a drink obtained by a brewing process in which a wort, preferably a hopped wort, is fermented so that at least a proportion of the sugars in the wort are converted into alcohol.
% (v/v): indicates a volume/volume percentage
% (w/v): indicates a weight/volume percentage
% (w/w): indicates a weight/weight percentage
DH (%): degree of hydrolysis of a protein (expressed in %) where DH is the ratio of the number of ruptured peptide bonds (h) to the number of available peptide bonds in the protein (hₜₒₜ) and is calculated from the formula: h/hₜₒₜ* 100. DH can be determined by the method described in Adier-Nissen, J.

Determination of the degree of hydrolysis of food protein hydrolyzates by trinitrobenzenesulfonic acid. J. Agric. Food Chem. 27, 1256-1262 (1979) and in Nielsen, P. M., Petersen, D. & Dambmann, C. Improved method for determining food protein degree of hydrolysis. J. Food Sci. 66, 642-646 (2001)”. PU: beer pasteurization unit as defined in Technology Brewing & Malting, Wolfgang Kunze, 5th revised English edition, 2014, VLB Berlin (1 PU=time (min)*1.393\hat{ }(temperature (° C.)−60° C.)).

The alcohol-free beer can be produced by known methods for brewing alcohol-free beer. In one embodiment, the beer may be brewed by the method for obtaining alcohol-containing beer, after which the alcohol is removed, for example by vacuum distillation, vacuum evaporation, heat treatment or membrane separation such as reverse osmosis. The alcohol-free beer may also be produced using special yeasts, by cold fermentation and/or early stopping of fermentation. These methods may also optionally be combined with a method for removing alcohol.

The brewing process that can be used for producing the alcohol-free beer according to the invention is similar to the traditional brewing process for making an alcohol-free beer. That is, the process starts from a malt, a mixture of dried and germinated grains, for example barley grains. Various types of malt may be used, which are generally commercially available. Examples of malt that can be used are malts that are offered by the Mouterij Dingemans NV such as among others Pilsen MD™, Wheat MD™, Pale Ale MD™, Munich MD™ and Amber MD™, malts from Mich. Weyermann® GmbH & Co. KG such as Abbey Malt@, Candy Malt@, CARAFOAM®, CARAPILS® and CARARED®. Other suppliers of malt include Boormalt NV and Castlemalting®.

Next, the malt is converted to a wort. In this process the malt will be mashed, wherein the malt is ground and mixed with hot water, followed by a temperature profile. In this way, the enzymes present in the malt become active again and they break down the starch further to sugars. After conversion of the starch, the mixture is filtered, after which the wort is obtained as a clarified liquid.

This wort is then boiled, wherein typically hops are also added to give the beer a desired (bitter) taste. The boiled wort is then clarified by means of for example a whirlpool. Then the wort is cooled quickly and then mixed with yeast and left for the wort to ferment. Cooling may be carried out in a plate cooler. Preferably the wort is cooled to a temperature of less than 25° C., for example less than 20° C. and preferably to a temperature of 18° C. Usually the cooling of the wort to the desired temperature is carried out within a time of less than 40 min, for example less than 30 min, for example within a time of 20 min.

Fermentation will preferably be carried out at room temperature, for example at a temperature between 15 and 25° C. or between 18° C. and 22° C. For making alcohol-free beer, use may be made of yeasts that are also used for alcohol-containing beers. Thus, for example Saccharomyces yeast strains may be used. Examples of such yeasts are Saccharomyces pastorianus and Saccharomyces cerevisiae. These yeasts convert both glucose and maltose sugars to alcohol, so that by the end of fermentation a considerable amount of alcohol will have been formed and an alcohol-containing beer is thus obtained, from which alcohol must then be removed or reduced.

According to a preferred embodiment of the invention, a yeast is used that does not convert all sugars in the wort to alcohol, so that after fermentation, a beer can be obtained with less than 0.5% (v/v) alcohol and thus no further alcohol has to be removed subsequently. These yeasts are for example yeasts that only convert monosaccharides such as glucose and fructose to alcohol. An example of such a yeast is the Pichia kluyveri yeast strain, which does not convert the maltose in the wort, and only converts the monosaccharides to alcohol. This offers the advantage that at the end of the brewing process, the beer contains a certain amount of sugars, which is beneficial for the recovery of sportsmen and sportswomen.

Thus, a beer brewed with the Pichia kluyveri yeast strain may comprise a total amount of maltose and maltotriose between 5 and 80 g/l, preferably between 10 and 50 g/l. In addition, the beer will also usually comprise an amount of higher dextrins (dextrins with 4 or more glucose units). Consequently, in this case the addition of sugars will not be necessary, or will be necessary to a smaller extent. Examples of Pichia kluyveri yeast strains that are usable are those described in WO 2014/135673 and that are commercially available from Chr. Hansen A/S, Denmark under the trade name NEER™. Another yeast for making alcohol-free beer is the yeast strain Pichia farinosa described in DD 288619.

The time required to ferment the wort will generally depend on the type of yeast strain that is used. In general, fermenting of the wort will take between 5 and 15 days, for example between 7 and 10 days. Using the Pichia kluyveri yeast strain, fermenting preferably takes place for between 6 and 9 days. Fermenting of the wort is stopped by cooling it to a temperature below 10° C., preferably below 5° C. This cooling will typically be rapid cooling, so that the fermentation process is ended quickly and completely. Preferably the cooling is carried out at a rate from 0.5 to 5° C. per hour, for example at a rate from 1 to 3° C. per hour.

The fermented wort that is obtained after fermentation is a turbid liquid, in which yeast and other solid substances such as added hops are present. These solids must be removed to obtain a clear beer. Usually filtration and/or centrifugation are used for this.

If yeast has been used that produces an ordinary alcohol-containing beer, the alcohol content will have to be reduced. For this purpose, reverse osmosis may be used, as described in for example DE 2323094, evaporation in a thin-film evaporator at a temperature below 70° C. as described in DE 1442238, adsorption removal of alcohol as described in DE 2405543 and DE 721249 or distillation.

According to the method described above according to the invention, an alcohol-free beer is thus obtained. According to the invention, a hydrolyzed protein is added to this alcohol-free beer. The hydrolyzed protein may be of animal origin such as a whey protein, or may be of vegetable origin such as protein from wheat, soybean or peas. The protein has a degree of hydrolysis that is preferably adjusted so that coagulation during pasteurization of the alcohol-free beer is avoided. The necessary degree of hydrolysis can easily be adjusted by a person skilled in the art and may depend on the composition of the alcohol-free beer. In general the degree of hydrolysis DH will be at least 5%, preferably at least 8% for example such as at least 10% or at least 12%. In a particularly preferred embodiment the degree of hydrolysis DH is at least 20% or at least 25%. Although a high degree of hydrolysis will generally lead to prevention of coagulation, too high a degree of hydrolysis may have an adverse effect on the final taste of the beer. Therefore in general the degree of hydrolysis DH in one embodiment of the invention will be between 5 and 50%, for example between 25 and 40%, for example between 7 and 45% or in another embodiment of the invention between 10 and 35%. The pH of the beer may also have an effect on coagulation after pasteurization when hydrolyzed protein is added. The pH will also have an effect on the taste perception of the beer. In general the beer will preferably have a pH between 4.0 and 5.5. If the pH of the beer is too low, this may give rise to an acidic, hard, bitter and drying taste. If the pH is too high, this may result in a dull, inadequate sensation of bitterness and acidity.

In a preferred embodiment of the invention, the protein is a hydrolyzed whey protein that is obtained as described in WO 2020/239998. Usable hydrolyzed proteins are commercially available and for example are available from Arla Foods Amba (Denmark), Kerry Group, Ireland and DuPont Nutrition & Biosciences.

The hydrolyzed protein, or optionally a combination of hydrolyzed proteins, is generally added to the beer as an aqueous solution. The amount of hydrolyzed protein that is added is determined by the desired final composition of the beer beverage with a view to optimal recovery of sportsmen and sportswomen, and taking into account the final taste of the beer. In general the amount of added hydrolyzed protein will be between 0.5% (w/v) and 10% (w/v), for example between 1% (w/v) and 5% (w/v).

Pasteurization may be carried out in accordance with a usual pasteurization process in the brewing of alcohol-free beer. Pasteurization may be carried out before filling the beer in its final packaging such as in barrels, bottles or cans. Pasteurization is preferably carried out after filling the beer in bottles or cans. Pasteurization methods that can be used are ‘flash’ pasteurization and tunnel pasteurization. ‘Flash’ pasteurization is suitable for pasteurizing the beer before it is filled in barrels. In this case the beer is heated rapidly in 20 to 30 seconds to a temperature of 71 to 72° C. Tunnel pasteurization of beer is usable for pasteurizing beer that has already been filled in bottles or cans. In this case the bottles or cans of beer are transported through a tunnel, wherein the bottles or cans are immersed in or sprayed with hot water or steam. After heating, the bottles or cans are cooled by spraying them with cold water. In general, the beer according to the invention will be pasteurized by tunnel pasteurization, wherein the beer is heated to a temperature between 60° C. and 75° C., for example 68, 69, 70, 71 or 72° C. According to one embodiment the beer is pasteurized with 2 to 80 PU, for example 4 to 60 PU or 10 to 50 PU.

The final taste of the beer is determined by the malt used, yeast, added hops and the brewing process. The taste of the beer according to the invention is also influenced by the addition of hydrolyzed protein. Some of the components in the preparation of the beer by the method of the invention may have a negative effect on the taste. Thus, during fermentation, sulfur-containing compounds may be formed, which lead to an unpleasant taste of the beer.

These compounds are preferably removed for example by adding tannins to the malt and/or the wort. The tannins bind to the sulfur-containing compounds and in this way they can be removed from the wort. Formation of sulfur-containing compounds occurs for example when using certain yeasts such as Pichia kluyveri yeast strains.

The taste of the final beer may be further adjusted by adding all kinds of flavorings. Examples of flavorings are in particular hops, which are added either via an extract or in a process that is known as ‘dry hopping’. Furthermore, substances may be added to give the beer a certain taste, for example the addition of fruit flavor, for example flavor of cherry, apple or pear to give the —beer a cherry, apple or pear taste, addition of chocolate flavor to obtain a chocolate taste, and so on.

If the alcohol-free beer free from coagulated matter that is obtained does not contain the desired amount of sugars, these may also be added. Preferably a beer is made that has a total amount of maltose and maltotriose that is between and 80 g/l, preferably between 10 and 50 g/l.

Other additional additives may be added to the beer provided they do not lead to coagulation of the beer, particularly coagulation during pasteurizing.

### EXAMPLES

In the examples given hereunder, the invention is illustrated in more detail, but without the intention of limiting the invention thereto.

### Materials

Malt-1: commercially available pilsner and caramel malt
CTZ hops: Columbus, Tomahawk and Zeus hop pellets T90 with 14.3% α-acids
Brewtan B: high molecular weight tannic acid available commercially from
Ajinomoto OmniChem sa/nv, Wetteren, Belgium
Yeast-01: Pichia kluyveri yeast strain available commercially from Chr. Hansen under the brand name NEER®
E1: ProDiem® Refresh Pea 7304 available commercially from Kerry Group, Ireland
E2: ProDiem® Refresh Soy 1307 available commercially from Kerry Group, Ireland
E3: Hyprol® Wheat 4107 available commercially from Kerry Group, Ireland
E4: Lacprodan® Hydro.365 available commercially from Arla Foods Amba, Denmark
E5: Instant BCAA 2:1:1, commercially available mixture of branched amino acids
E6: Soypro® 950F soybean protein available commercially from Prinova, London, UK
E7: UltraWhey XP Instant Sunflower, whey protein available commercially from Volar International Ltd.

### Coaqulation Test

A commercially available alcohol-free beer (Jupiler 0.0) was used for determining whether the addition of protein leads to coagulation of alcohol-free beer during pasteurization. The protein to be tested was added in the amount stated in Table 1 to 100 ml of degassed Jupiler 0.0 at room temperature. After stirring for 1 hour, the samples were pasteurized in a hot water bath until a core temperature of 72° C. was reached in the sample. The samples were then inspected visually for the formation of coagulation. The results are given in Table 1.

TABLE 1

| Sample | protein | amount (g) | visual assessment of the sample |
|---|---|---|---|
| 1 | E1 | 3.75 | no coagulation, clear |
| 2 | E2 | 3.75 | no coagulation, clear |
| 3 | E3 | 4.1 | no coagulation, slight turbidity |
| 4 | E1 + E3 | 1.9 + 2.1 | no coagulation, slight turbidity |
| 5 | E2 + E3 | 1.9 + 2.1 | no coagulation, slight turbidity |
| 6 | E4 | 3.5 | no coagulation, clear |
| 7 | E5 | 3 | coagulation |
| 8 | E6 | 3 | severe coagulation |
| 9 | E7 | 3 | severe coagulation |
| 10 | E4 | 3 | no coagulation, clear |

It can be seen from Table 1 that the samples to which hydrolyzed protein was added do not display any coagulation and are usually clear or slightly turbid (samples 1-6 and 10). The other samples display severe coagulation in the case of addition of protein (samples 8 and 9). Coagulation was also observed after pasteurization with addition of amino acids (sample 7).

Example of a Brewing Process for Producing a Protein-Containing Alcohol-Free Beer that is Free from Coagulated Matter, According to the Invention

An alcohol-free beer was brewed according to the following recipe. Mashing of Malt-1 was carried out by mixing Malt-1 with hot water (50° C.) and this temperature was maintained for 30 minutes. The temperature was then increased to 75° C. (at a rate of 1.5-2° C./min) and was maintained for 60 min. Mashing was ended by heating to 78° C. 0.1% (w/w) Brewtan B was added to the malt at the beginning of mashing.

The mixture obtained was then filtered and the wort obtained was used after adding CTZ hops and was boiled for 60 minutes. 10 min before the end of boiling, 0.016% (w/w) Brewtan B was added and the pH of the wort was adjusted to 4.4 by adding lactic acid. The wort was cooled to 18° C. by means of a plate cooler and aerated with sterile air. 20 ml of Yeast-01 to 500 liters was added while the wort was filled in the fermenter. During the days of fermentation, the wort was recirculated continuously by means of a pump to keep the yeast in suspension. The temperature was maintained at 18° C. during the main fermentation. On day 8 of fermentation, the temperature was lowered to 2° C. to stop fermentation.

After fermentation, the beer was filtered on BECOPAD® cotton filter sheets (EATON, USA) with a nominal retention of 0.5-0.7 μm and forced-carbonized to ˜5.5 g C02/L. Beforehand bottling, 14.5% (v/v) of hydrolyzed protein E4 solution (24.9% w/v), and 0.16% of a hop extract mixture were added. The beer was then filled in 250 ml bottles and pasteurized by tunnel pasteurization. The beer so obtained had an alcohol content of about 0.4% (v/v) and had a pleasant taste sensation.

The beer obtained had an amount of protein of about 3.3% (w/v) and the total amount of maltose and maltotriose was between 3.5% and 3.7% (w/v). The beer was assessed independently by a panel of eight members for taste and aroma of malt, hops, esters, proteins and maturity, as well as general appreciation, fullness, bitterness, sweetness, tartness, acidity and carbonation.

The beer had a higher than average general appraisal. It received high scores for aroma and taste of hops, which illustrates the effect of the added hops. The content of >3% w/v protein did not result in abnormally high values for protein taste or aroma. The beer obtained is thus a pleasant and easily drinkable alcohol-free beer that may promote the recovery of sportsmen and sportswomen. Because of the perception of the drink as a beer, this facilitates distribution and sale of the drink in canteens and cafes where sportsmen and sportswomen often meet up after sports activities.

1. A method for making an alcohol-free beer that is free from coagulated matter, with an alcohol content of not more than 0.5% (v/v), preferably not more than 0.4% (v/v), comprising the steps of fermentation of a wort, addition of a hydrolyzed protein and pasteurization.

2. The method for making an alcohol-free beer that is free from coagulated matter as claimed in claim 1, comprising the steps of
a. supplying a wort,
b. fermenting the wort with a yeast at a temperature from 18° C. to 25° C.,
c. ending the fermentation by cooling the wort to obtain a fermented wort,
d. filtering and/or centrifuging the fermented wort,
e. if the alcohol content in the fermented wort is 0.5% (v/v) or more, reducing the alcohol content in the fermented wort to less than 0.5% (v/v), preferably less than 0.4% (v/v),
f. adding a hydrolyzed protein to the fermented wort, and
g. pasteurizing.

3. The method as claimed in claim 1 or 2, wherein fermentation is ended by cooling to a temperature of less than 10° C., preferably less than 5° C.

4. The method as claimed in claim 1, 2 or 3, wherein the hydrolyzed protein is selected from the group of whey protein and vegetable proteins and combinations thereof.

5. The method as claimed in claim 4, wherein the vegetable protein is selected from the group of pea protein, soybean protein, wheat protein and combinations thereof.

6. The method as claimed in one of the preceding claims, wherein the yeast is a Pichia kluyveri yeast strain and fermentation is ended in such a way that an alcohol content in the brew is obtained of less than 0.5% (v/v), preferably less than 0.4% (v/v).

7. The method as claimed in one of the preceding claims, wherein one or more flavorings are added to the brew.

8. The method as claimed in claim 6, wherein the flavoring is hops or a hops derivative.

9. The method as claimed in one of the preceding claims, wherein the wort is made by a process that comprises the following steps
a. supplying a malt
b. mashing the malt
c. boiling and then cooling so that a wort is obtained.

10. The method as claimed in claim 9, wherein a tannic acid is added during mashing of the malt.

11. The method as claimed in claim 9 or 10, wherein hops are added.

12. The method as claimed in one of the preceding claims, wherein the degree of hydrolysis (DH) of the hydrolyzed protein is at least 5%, preferably at least 7% and most preferably between 8% and 30%.

13. An alcohol-free beer that is free from coagulated matter, with an alcohol content of not more than 0.5% (v/v), preferably not more than 0.4% (v/v), which contains one or more hydrolyzed proteins.

14. An alcohol-free beer that is free from coagulated matter, wherein the one or more hydrolyzed proteins are present in a total amount of between 0.5% (w/v) and 10% (w/v).

15. The alcohol-free beer that is free from coagulated matter as claimed in claim 13 or 14, wherein the beer contains maltose and maltotriose and the total content of maltose and maltotriose is between 5 and 80 g/l, preferably between 10 and 50 g/l.

16. The alcohol-free beer that is free from coagulated matter as claimed in one of claims 13 to 15, wherein the beer further contains higher dextrins.

17. The alcohol-free beer that is free from coagulated matter as claimed in one of claims 13 to 16, wherein no coagulated matter is present or the amount of coagulated matter is not more than 0.05% (w/v).

18. The alcohol-free beer that is free from coagulated matter as claimed in one of claims 13 to 17, wherein the alcohol-free beer can be produced by the method of one of claims 1 to 12.
